(19) United States
(12) Patent Application Publication
(10) Pub. No.: US 2007/0033093 A1
(43) Pub. Date: Feb. 8, 2007

(54) Automated proposal development toolset

(76) Inventors: Jay D. Divine, St. Louis, MO (US); Wilson D. Yates III, Lake St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/198,243

(22) Filed: Aug. 5, 2005

(51) Int. Cl. G07G 1/00

(52) U.S. Cl. 705/10

(57) ABSTRACT

An automated tool set for developing a business proposal in response to a customer solicitation. The tool set includes a workbook divided into four sections, each section correlated to one of four phases of a typical new business campaign process. Each section consists of a set of specific questions designed to identify and develop data required for that particular phase. The workbook also contains briefing sheet templates for conducting management reviews at the conclusion of each phase, business plan templates for drafting a business plan, updating the plan, and creating a final, approved business plan. The workbook further contains an automated data structuring framework for answering each question; so, as data is entered into the workbook, it is also automatically entered into the management briefing sheet templates, and the business plan and draft proposal templates. This toolset enables a proposal team to identify, collect, develop, organize, and readily use collected data needed to proactively pursue new business opportunities as they mature, and to develop a detailed proposal in response to a customer's solicitation.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to process an automated for developing new business through government contracts and the like; and more particularly, to a set of business tools for capturing business acquisition campaign data and automatically producing an integrated set of sequenced materials which employ this data to acquire new business. The toolset includes facilitates creating integrated materials comprising, in sequence, (a) management briefing sheets reviewed at established campaign milestones, (b) a comprehensive business plan with automated updates, and (c) a draft proposal for submission to the government or other business awarding a contract. Various drafts of the proposal are prepared and updated during different phases of the process.

The present invention is especially beneficial for streamlining the organization of data during a new business acquisition campaign, and in the preparation of complex technical proposals submitted to governmental agencies and business clients. These proposals can range in size from fifty or so pages to hundreds, or thousands of pages, and often include highly technical and complex content. The process of the present invention allows a campaign/proposal team to develop and organize the requisite information and materials required to execute, manage, and review a business development campaign, and to develop and produce a technical proposal more effectively, faster, and more cost-effectively than is possible using conventional approaches.

In order to obtain new business, many companies conduct lengthy new business campaigns to (a) identify potential new business opportunities, (b) to mature a given business opportunity, (c) to develop an offer to solve a customer's problem or to respond to an expressed customer's need, and then (d) to prepare and submit a proposal to the government agency (federal, state, or local) or company awarding the business. The proposal is then usually compared by the customer with competing proposals submitted by others. Most often, there is a predetermined set of criteria against which the proposals are judged in a formal competitive evaluation, and after which the winning proposal is selected. A proposal that fails to win in a competitive selection process often represents a major setback, and sometimes can even cause a company to go out of business. Major new business proposals to the government, especially those required of aerospace and defense contractors, are recognized as presenting a chronic challenge to the contractor, and one that stubbornly resists being solved by management.

Typically there are four phases to a new business acquisition campaign process. Phase 1 involves recognizing that a potential business opportunity exists; which is to say that a customer has a problem that needs to be solved, or that there is an opportunity to be exploited. Phase 2 focuses on maturing data associated with the identified opportunity by (a) conducting further research to fully understand the customer's requirements, whether independently or with the customer's involvement, and (b) by investigating potential solutions to solve the problem. Phase 3 involves developing a specific offer, or solution, to the problem. Phase 4 requires preparing and documenting the offer in a proposal which formally responds to a customer's solicitation.

Within each phase of a typical business development campaign process, certain data has to be identified, gathered or developed, and documented. Company management usually conducts a formal management review of the data at the end of each phase, this review resulting in a pass/fail decision on whether or not to continue pursuit of the business opportunity into the next phase.

Conventional approaches to gathering new business campaign data have seldom been affected by an organized, integrated effort that builds from one business opportunity to the next, or even from one phase to another within a given pursuit. Established protocols typically provide very little guidance on just what data needs to be collected during each phase of the campaign process; and as a result, each business development team is left to its own resources as to what data to collect for presentation to management. Program managers often must manually create briefing charts for each management review using the data that has been collected. As a result, the data is often incomplete when presented, and a management review turns from a brief (i.e., 20-30 minute) review-and-approval session to a long, drawn out (i.e., one-to two-hour) work session in which management labors to make sense of what data is presented, helps the program manager identify needed data that is missing; i.e., “check off the required boxes”, and make intelligent “go/no-go” decisions. Because gaps in the data are so common, multiple reviews are often required at each phase. This is not only inefficient and time-consuming, but often requires additional budget allocations. Business plans are manually created (if they are created at all) to help management understand the impact a program will have on present and future business operations of the company or operating division. A program business plan (if one is created) can provide much needed substantiation for the materials briefed to management during the management review that takes place at the conclusion of each of the four phases outlined above.

### BRIEF SUMMARY OF THE INVENTION

The present invention is directed to providing an integrated toolset which facilitates identifying, capturing, developing, and organizing the campaign data needed to prepare a proposal, particularly proposals involving complex programs and technologies. The toolset then automatically (a) builds management review briefing sheets, (b) builds a program business plan, and (c) provides a substantial foundation draft for the technical proposal which responds to the customer solicitation. The integrated toolset comprises a workbook segregated into four chapters or sections, each chapter or section being correlated to one of the four phases of a typical new business campaign as previously outlined. The briefing sheets are for presenting proposal data for management review at the end of each phase. A business plan template and a proposal content template are provided as attachments to the workbook to further assist management throughout the process.

The toolset enables necessary data to be accumulated early on, and relatively quickly, with less effort required than has been previously necessary. The toolset further ensures that the chronic re-duplication of effort so common to the documentation for a new business campaign is eliminated. The data then seamlessly flows through each phase of the process, is readily supplemented, and management review time is significantly reduced at the end of each phase in the proposal process. This has advantage of reducing time required to create a proposal, the attendant cost, and the number of people involved.

Other objects and features of the present invention will in part be apparent and in part be pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIGS. 1A and 1B are a block diagram representation showing an overview of the four-phase new business campaign process; and,

FIG. 2 illustrates how the toolset integrates data collected during each phase of the campaign process into a Program Capture Workbook and automatic links provided to the Program Business Plan, Management Briefing Sheets for each end-of-phase management briefing, and to a Draft Proposal submitted to a customer.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. Since various changes could be made in the above constructions without departing from the scope of the invention, it is intended that all matter contained in the above description or shown in the accompanying drawings shall be interpreted as illustrative and not in a limiting sense.

By way of an overview, an Automated Proposal Development Toolset (APDT) of the present invention is designed to provide a common-sense solution to the perpetual challenge of developing high quality content for complex advanced technology proposals. The toolset is especially designed to, for example, streamline the actual writing of aerospace and defense proposals to the U.S. Department of Defense and related government agencies. The APDT approach is product-centered, hands-on, and how-to focused. It is carefully configured to complement and directly supports the disciplined acquire business processes developed by defense contractors and others involved in bidding for, and acquiring “high tech” business. It works by collecting, organizing, integrating, automating, and re-presenting data from the earliest moments of a capture team's identification of a business development opportunity, through the actual writing of the draft proposal itself.

As described further hereinafter, the basic mechanism used is an electronic “workbook” in a customized Microsoft Word® application. The workbook incorporates detailed questionnaires to first prompt a business development team or capture team leader, and subsequently a program manager, to capture the right data at the right points in the pursuit of the business opportunity. Then, in a series of automated builds using pre-developed templates and frameworks, the workbook toolset links and reshapes the data to fill-in or populate management review briefing documents, a continuously updated business plan, and ultimately the proposal itself. Although the workbook is rigorously product-focused (that is, proposal-focused), it actually reinforces established acquire business processes because it maps directly (and at a significant level of detail) to all key process elements. As a result, it substantially reduces duplication of effort, reduces cost, accelerates progress, and improves the overall quality of proposal development efforts.

As discussed previously, any new business campaign process first involves identifying whether a potential new business opportunity exists. This, as noted, is Phase 1. Next, the process involves developing and maturing an information base related to the new business opportunity, identifying potential solution sets to solve the customer's problem, and determining the business impact on the contractor. This is Phase 2. A solution set (or offer) is now developed to respond to the customer's problem or opportunity and the offer is submitted to, and approved by, company management. This is Phase 3. Once the customer's solicitation is released, the approved offer must be documented in a format defined by the solicitation. This is Phase 4.

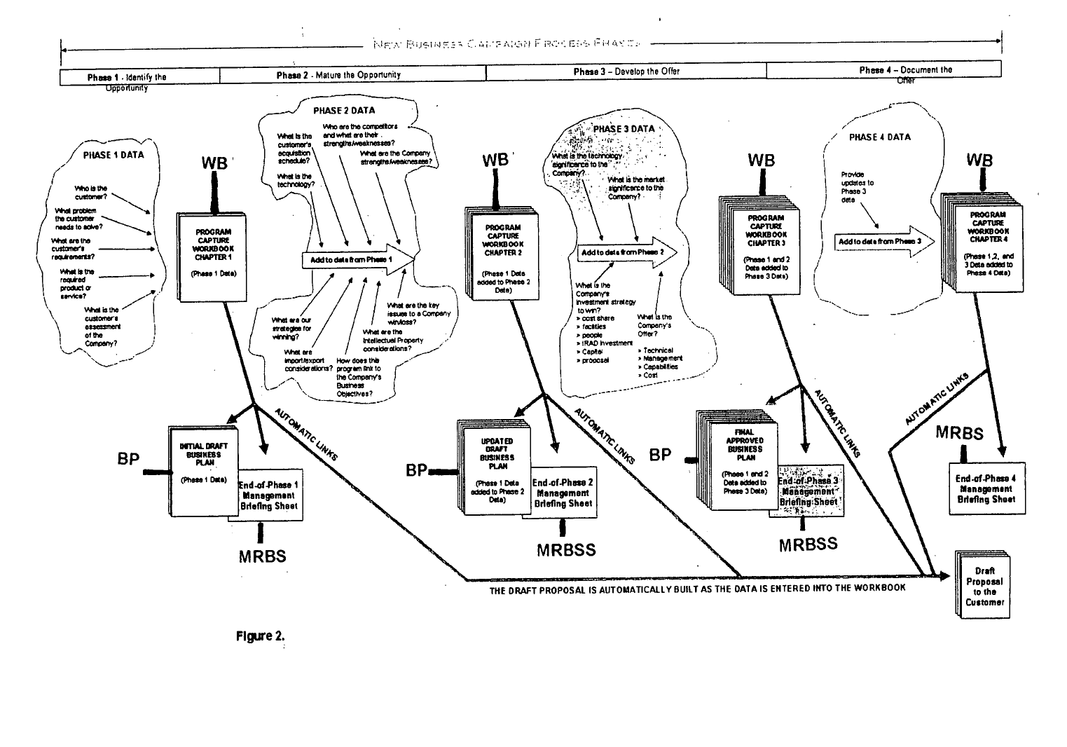

In FIG. 2, a Workbook WB Chapter 1 is correlated to Phase 1 of the process and is associated with identifying that a potential business opportunity exists and that a prospective customer has a problem that needs to be solved. Workbook Chapter 2 is correlated to Phase 2 of the process and is associated with maturing the data associated with the business opportunity. This involves conducting further research, both independently, and with the potential customer. Workbook Chapter 3 is correlated to Phase 3 of the process and is associated with developing an offer to respond to the problem the customer needs to solve. Workbook Chapter 4 is correlated to Phase 4 of the process and focuses on documenting the approved offer in a proposal to respond to a customer solicitation. Each workbook chapter contains specific questions associated with the minimum data set that needs to be gathered during that phase of the business development campaign. In accordance with integrated tool set directions, a program manager (PM), or his designee, answers each question in a space provided in the workbook, beginning with Chapter 1 and ending with Chapter 4. Importantly, and in accordance with the invention, as this data is collected and entered into the workbook in the course of the new business campaign, the data is automatically linked to management review briefing sheets MRBS, a business plan BP template, and a proposal foundation template. Typically, there is a formal management review at the end of each phase of the business development campaign. The outcome of the management review is a pass/fail decision on whether or not to continue with the pursuit of the business opportunity.

Those skilled in the art will understand that for each pursuit of a business opportunity, a copy of the workbook is initially downloaded to a laptop computer, for example, and configured for the particular project by the business development team leader or capture team leader for the project. During the early phases of the project, data collection and input, and workbook configuration control, are thus in BD/CTL hands. As soon as a program manager is named, the electronic workbook is transferred to his or her laptop computer, along with the responsibility for data collection and data input and configuration control. Maintaining the electronic workbook in “read only” form on an access-controlled server permits key managers to monitor the progress and status of the project throughout the pursuit and the proposal development effort. To install the APDT for individual business units of a corporation, the APDT is customized and tailored to the requirements of each unit and the components of the APDT to the business model(s) and business development opportunities of each unit.

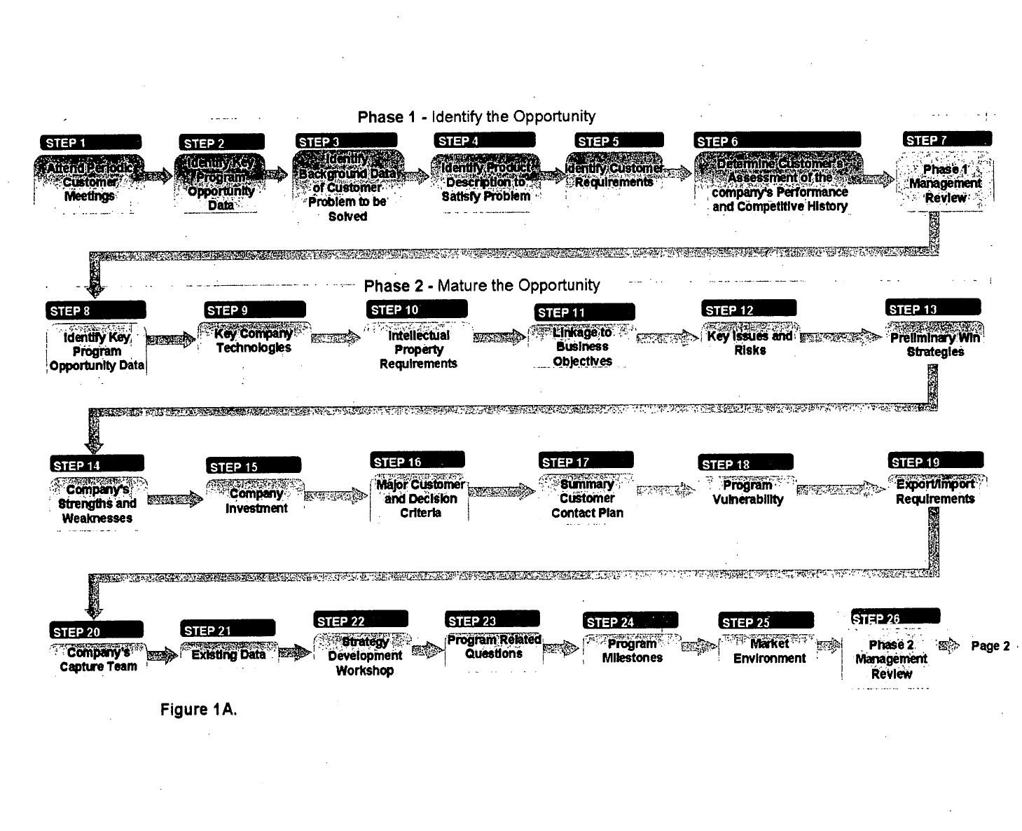

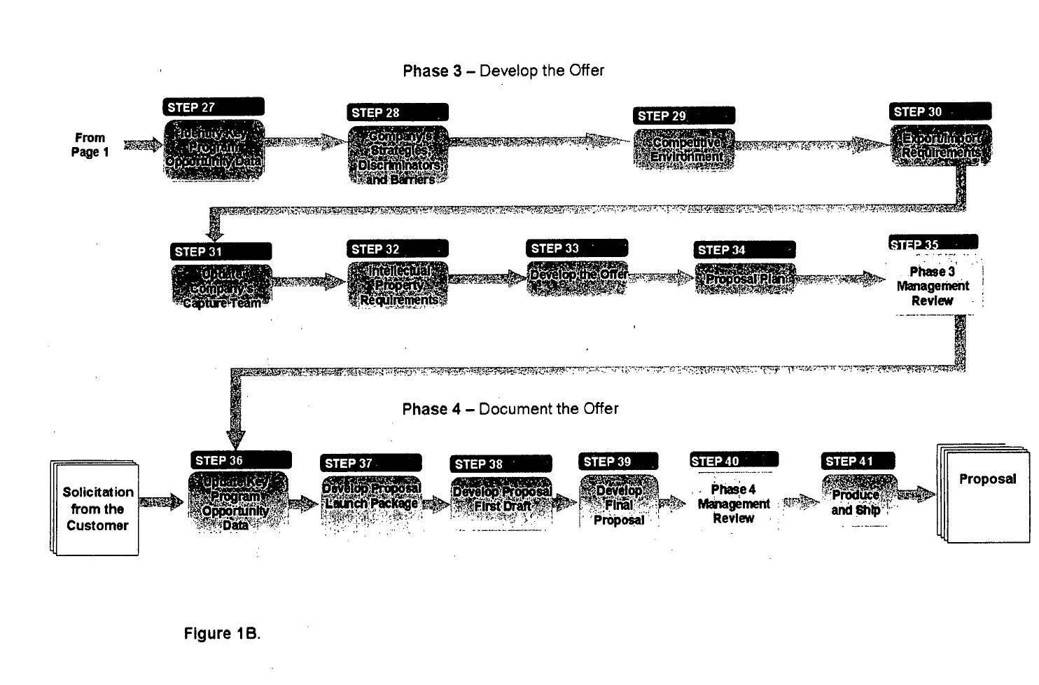

Referring to FIGS. 1A and 1B, Phase 1 involves a series of steps first including attending periodic customer (government or other business') meetings (Step 1). If a business opportunity presents itself, steps 2 and 3 are used to identify key program data related to the opportunity, and background data for the particular problem to be solved. Using this baseline set of information, the description of a product to solve the problem is identified (Step 4). Next, customer requirements are identified (Step 5), as well as the customer's assessment of the company's performance and competitive history (Step 6). Once steps 1-6 are completed, a first phase management review is conducted (Step 7). If the results of the review are positive, the company proceeds to Phase 2. Otherwise, the project is dropped.

Phase 2 requires that a number of steps be performed. Although shown in FIG. 1A as being performed sequentially, many of the steps can be performed in parallel so the actual timeline for conducting Phase 2 is not overly long. Phase 2 requires identifying key program opportunity data (Step 8), as well as key company technologies (Step 9), and intellectual property (IP) assets and requirements (Step 10). Next is identifying links to the company's business objectives (Step 11) and the attendant issues and risks involved (Step 12). With the data related to the foregoing, preliminary strategies to win the business are developed (Step 13) and an assessment of the company's strengths and weaknesses as related thereto is made (Step 14). This leads to a determination of the company's investment (cash, facilities, personnel, etc.) which will have to be made (Step 15). Customer and decision criteria are now evaluated (Step 16) and a summary customer contact plan is formulated (Step 17). The vulnerability of the proposed program is then evaluated (Step 18). If necessary, import/export requirements are determined (Step 19). A company team for now capturing the business is identified (Step 20) and reviews existing data (Step 21) as part of a development strategy workshop (Step 22) to put together program related questions (Step 23) and determine milestones for submitting a proposal to obtain the business (Step 24) in view of the perceived market environment (Step 25). A second management review is now held (Step 26); again to determine whether or not to proceed and on what basis.

If the program does go forward, then as part of Phase 3, key program opportunity data is identified (Step 27) as is company strategies, discriminators as to what strategies to pursue and what barriers may exist as to a particular strategy. The competitive environment is evaluated (Step 29) and import/export requirements are again reviewed (Step 30). The capture team identified in Step 20 is now updated (Step 31). IP requirements are again evaluated (Step 32) based on the strategies now being pursued. A development offer and proposal plan are formulated (Steps 33 and 34) and this submitted for management review (Step 35).

Often, Phases 1-3 are performed in expectation of a solicitation from a customer, it being understood that informal and/or formal discussions are going on with the customer throughout the period these three phases are being conducted. Once a formal solicitation is received from the customer key program opportunity data is updated (Step 36) in light of the contents of the solicitation and a proposal launch package is developed (Step 37). First (and often additional) proposal drafts are prepared and reviewed (Step 38) before a final proposal is completed (Step 39). A management review is made of the final proposal (Step 40) and, when approved, the proposal is produced in final form and sent to the customer (Step 41).

The Automated Proposal Development Tool

In accordance with the method of the present invention, the automated proposal development tool for use in Phases 1-4 is implemented using a computer (not shown) programmed with a master workbook file that authorized personnel can access and download onto their desktop or laptop computers. Once downloaded, a designated data manager, program manager, or proposal manager saves the file under a unique project-identifier label, and takes ownership and responsibility for configuration control of the project data. The responsible individual enters into the workbooks basic program related data that is known, such as program title and the customer. The responsible individual then reviews questions relevant to Phase 1 of the workbook, enters known data in the workbook, and determines the best way to identify, collect, and develop missing or needed data.

Relevant Phase 1 questions include:
Who is the customer?
What problem does the customer need solved?
What are the customer's requirements?
What product or service which would fulfill these requirements?
How does the customer assess the company?
   As data related to these questions is entered into the workbook in the appropriate locations (Steps 2 and 6), the data is automatically linked to, and entered into a Phase 1 management briefing sheet, an initial draft of the Program Business Plan, and a Draft Proposal template.

Once all the questions are answered, the responsible individual schedules a Phase 1 management review (Step 7). During the review, the responsible individual opens the Phase 1 management review briefing sheet, usually stored in his/her personal computer, projects it for display via electronic means, and briefs management on the potential new business opportunity. Prior to the Phase 1 management review, the responsible individual may also print out copies of the initial draft of the Program Business Plan and provide it as supporting data to the reviewers. Another option is for the responsible individual to provide the Program Business Plan in an electronic format for review. The initial draft of the Program Business Plan provides substantiation of the summary data briefed during the management review. Since the workbook contains a minimum set of data elements that a cross section of management reviewers have determined to be required for Phase 1, and the responsible individual has collected all the required data by fully answering the workbook questions, the management review becomes a short (20 to 30 minute) review session for approval of the potential new business opportunity; rather than a lengthy working session to identify and develop critical data that is missing.

Once management approves that the requirements of Phase 1 have been met and that Phase 2 should start, the Program Manager takes over responsibility for the workbook file if he or she has not already done so. The Program Manager reviews unanswered questions in Phase 2 of the workbook, and determines the best way to identify, collect, or develop the missing data.

Phase 2 questions include:

What is the technology that is involved for implementing the solution?

What is the customer's schedule?

What are the company's strengths and weaknesses?

How will the proposal link to the company's objectives?

What should the company's strategy be?

What are the affects if the company wins or loses its proposal?

Who are the competitors and their strengths and weaknesses?

What are the import/export and IP considerations involved?

As the data is elicited and entered into the workbook in the appropriate locations, the data is automatically linked to, and entered into the Phase 2 management briefing sheet, the updated draft program business plan, and the draft proposal template. Once all questions are answered, the Program Manager schedules a Phase 2 management review (Step 26).

During the review, the Program Manager accesses the Phase 2 management review briefing sheet on his or her personal computer and displays the sheet to the participants. Using the sheet, the manager briefs management on what has been done to mature the data initially associated with the business opportunity, including the results of any research or trade studies conducted. As before, prior to the management review, the manager can also print out copies of the updated draft of the program business plan or provide it to provide the reviewers in an electronic format. The updated program business plan provides a detailed substantiation of the summary data briefed during the management review. Since the workbook contains the minimum set of data elements that a cross section of management reviewers have determined is required for Phase 2, and the Program Manager has collected all the required data by fully answering the questions designed to identify, collect, and develop the data, this Phase 2 management review again becomes a short meeting to approve the potential new business opportunity, as opposed to a lengthy working session to identify and develop critical, but missing, data.

Once management agrees that all requirements of Phase 2 have been met and that Phase 3 should start, the Program Manager reviews the unanswered questions in Phase 3 of the workbook, and determines the best way to identify and collect or develop the missing data.

Phase 3 questions include:

What are the technology and market significance of the potential new business to the company?

What is the company willing to invest (facilities, people, capital, etc.) to win the business?

What kind of offer will the company put forth?

As the missing data necessary to answer these questions is identified and entered into the workbook in the appropriate locations, it is also automatically entered into the Phase 3 management briefing sheet, the final program business plan, and the draft proposal template. Once all questions are answered, the Program Manager schedules a Phase 3 management review (Step 35).

During this review, the Program Manager opens the Phase 3 management briefing sheet from his or her personal computer and displays it to the meeting participants to brief management on the offer that has been developed. Again, prior to the management review, the manager can also print out copies of the updated draft of the program business plan or provide it to the reviewers in an electronic format. Importantly, the final program business plan provides detailed substantiation of the summary data briefed during the management reviews. Since the workbook now contains the minimum set of data elements that management reviewers determined were required for Phase 3, and the Program Manager has collected all the required data by fully answering the workbook questions; even though the proposal to be submitted may have substantial impact on the company, the management review is now a relatively short review-and-approval meeting for the potential new business opportunity, rather than another lengthy working session.

Once management validates that all requirements of Phase 3 have been met and that Phase 4 should start, the Program Manager is ready to develop the draft proposal (Steps 38 and 39). The Program Manager follows the instructions in the Phase 4 section of the workbook to document the offer that was developed during Phase 3. The Program Manager first reviews and updates the program data in the table on a first page in Phase 4 of the workbook. When the updated data is entered into the workbook in the appropriate locations, the data is automatically linked to, and entered into the Phase 4 management briefing sheet and draft proposal template.

It will be appreciated that a significant advantage of the process of the present invention is that as new data is entered into the workbook, regardless of the chapter, that the management briefing sheets, proposed business plan, and draft proposal template used to prepare the final proposal are automatically updated through the established data links so the proposal is always as current as the most recently entered data.

The Program Manager, and designated subject matter experts on the proposal team, now review the draft proposal content against the solicitation's proposal structure and formatting requirements, and against their own proposal outline and compliance matrix. They then add any additional data (in the form of narrative text or graphs) needed to complete the proposal.

Once the draft proposal is finished, the Program Manager schedules a Phase 4 management review (Step 40). During this review, the Program Manager again opens the Phase 4 management briefing sheet from his or her personal computer and displays it, via electronic means, to help him or her brief management on the proposal developed in response to the customer solicitation. A recommended practice is for the Program Manager to also provide the draft proposal in electronic or hard copy format to the reviewers in advance of the Phase 4 management review. This meeting gives management a final review opportunity at which the proposal is approved for submittal to the customer.

As previously discussed, once management review of the final draft of the proposal is completed and approval is given, the proposal is produced in final form and sent to the customer.

It is important to note that the above described process provides an integrated set of tools that enables responsible personnel to automatically and accurately build, compile, and complete management review briefing sheets, a continually updated program business plan, and proposal templates and content which are the foundation of the technical proposal used to respond to the customer solicitation. The briefing sheets, business plan template, and proposal templates all require certain common information. The automatic linking capabilities of the workbook insures that when commonly required data or information is first entered into the workbook, it is automatically entered in each other location (briefing sheets, business plan template, proposal template) where it is required. This both saves time and insures the accuracy of the information. If an entry has to be corrected or supplemented, making the correction, or entering the supplementary information automatically flows it through to the appropriate location on each related document. It will be understood that some information may initially be required only for one document but later may be needed to supplement information in another document. In addition to data entered by the Program Manager or responsible entry person, data can also be imported from other sources into the workbook. As noted, the workbook is implemented on a computer and the various documents and data files associated with the workbook and each workbook chapter are easily downloaded to the PC's or laptops of personnel working on the proposal.

Segregating the process into four interrelated chapters used for putting together a new business campaign is important because it insures the incremental performance of each element necessary in determining if preparing a proposal is worthwhile, and if so, that it is given the attention it requires. Then, by having all collected data flow through the process from one phase to the next, the time required to create the proposal is significantly reduced, as is the cost to prepare the proposal, and the number of people involved in its preparation.

In view of the above, it will be seen that the several objects and advantages of the present invention have been achieved and other advantageous results have been obtained.

Having thus described the invention, what is claimed and desired to be secured by Letters Patent is:

1. A business process facilitating the capture, development, and organization of data used by a company in identifying and maturing a business opportunity and in developing a proposal to acquire new business comprising:
a detailed set of questions related to each of a series of phases in the process:
a methodology for acquiring, organizing, and storing data used to answer each question;
automatically linking data acquired during each phase to subsequent phases so the data is combined with previously acquired and stored data; and,
throughout the process using the data to prepare briefings for management reviews held at the completion of each process phase and a business proposal to be submitted to a customer to acquire the new business.

2. The process of claim 1 including a workbook and the process includes accumulating the data in the workbook.

3. The process of claim 2 in which the workbook includes a separate section for each phase of the process, each section including the set of questions related to that phase.

4. The process of claim 3 in which the sections of the workbook are linked together so filling in answers to the questions in a workbook section automatically links the data to appropriate locations in other sections for use in preparing for the management review briefing and for preparing the business proposal.

5. The process of claim 4 in which the briefings and business proposal include documents for management review and the linked data is automatically incorporated into the documents.

6. The process of claim 5 in which filling in the answers to questions in subsequent chapters of the workbook allows documents used for management briefings, and the business plan to be automatically updated.

7. The process of claim 3 further including importing data from external sources into a chapter of the workbook and automatically linking this imported data to other workbook chapters.

8. The process of claim 1 in which the set of questions relating to the first phase relates to identifying if a potential business opportunity exists, the prospective customer and the customer's requirements, and whether the company can fulfill these requirements, the data acquired to answer this set of questions enabling company management to determine whether or not to pursue the opportunity.

9. The process of claim 8 in which the set of questions relating to the second phase relates to maturing the opportunity including technology is involved in implementing a solution for the customer, the customer's schedule, the company's strengths and weaknesses and those of its competitors, how the opportunity relates to the company's business objectives, and the affect on the company if its proposal is accepted or rejected, the data acquired to answer this set of questions enabling company management to determine how to prepare the company's proposal.

10. The process of claim 9 in which the set of questions relating to the third phase relates to preparing the company's proposal including the technology and market significance of the potential new business to the company, what the company is willing to invest in the way of resources to obtain the business, and the type of proposal the company will make, the data acquired to answer this set of questions enabling company management to complete preparation of the company's proposal.

11. The process of claim 10 in which the set of questions relating to the fourth phase relates to how the customer wants the company's proposal presented and the data acquired to answer this set of questions enabling company management to determine how to present the company's proposal.

12. The process of claim 2 in which attached to the workbook are management briefing sheets for each phase of the process, a proposed business plan template, and a draft proposal template for formulating the proposal, and acquiring and storing data in the workbook automatically links the data to appropriate locations on a briefing sheets, the business plan template, and the draft proposal template.

13. The process of claim 12 in which as new data is entered into the workbook, regardless of the phase, the management briefing sheets, proposed business plan, and draft proposal template used to prepare the final proposal are automatically updated through the established data links so the management briefing sheets, proposed business plan, and draft proposal template are always as current as the most recently entered data.

14. The process of claim 1 further including throughout the process using the data to prepare briefings for management reviews held at the completion of each process phase.

15. The process of claim 1 further including throughout the process using the data to update business plan templates used for drafting a business plan.

16. An integrated tool used by a company in facilitating the capturing, developing, and organizing of data used in preparing management review briefing sheets, a business plan, and a technical proposal in response to a customer solicitation, comprising:
a workbook divided into four sections, each section correlating to one of four phases for a new business campaign process;
questionnaires for identifying, developing, and entering program-related data into each of the four workbook sections, each questionnaire consisting of a set of specific questions related to the phase;
linking the program-related data to a management briefing sheet used by management during a review of each phase;
further linking the program-related data to a self-updating program business plan; and,
still further linking the program-related data to a draft proposal template used to produce a business proposal submitted in response to the customer solicitation.
